(19) United States
(12) Patent Application Publication
(10) Pub. No.: US 2020/0082419 A1
(43) Pub. Date: Mar. 12, 2020

(54) System, Method, and Computer Program for Using Social Media to Make Personal Fashion Choices

(71) Applicant: EyeOn.pro Ltd., Timnath, CO (US)

(72) Inventors: Craig Dean Hanson, Elk Grove, CA (US); Paul Aaron DeVoe, Timinath, CO (US)

(21) Appl. No.: 16/126,676

(22) Filed: Sep. 10, 2018

(51) Int. Cl. G06Q 30/02; G07C 13/00; G06Q 50/00; G06Q 30/06

(52) U.S. Cl. CPC G06Q 30/0203; G07C 13/00; G06Q 30/0253; G06Q 30/0623; G06Q 50/01

(57) ABSTRACT

The presently disclosed technology provides a system, method, and computer program product for retailers to give product options to shopping consumers on a social media platform that consumers can use to make selections based on feedback from their social network. The network is an informal feedback loop that gives the consumer insight in their purchase decision before their purchase.

### BACKGROUND

Consumers contemplating a fashion purchase make the decision desiring feedback from those they trust; their family, friends or experts. A clear understanding if their decision will be well received by their peers and social network of friends needs a platform for evaluation. Gaining early feedback from their social network will solidify their confidence in their purchase. Retailers often have little insight into the consumer comparisons that are contemplating and often little understanding of how these decisions are made.

### FIELD OF THE INVENTION

The present invention relates generally to social feedback in the retail experience.

### SUMMARY

A system, method, and computer program product are provided for retailers to give product options to shopping consumers on a social media platform that consumers can use to make selections based on feedback from their social network. The network is an informal feedback loop that gives the consumer insight in their purchase decision before their purchase.

### BRIEF DESCRIPTION OF THE DRAWINGS

FIG. 1 illustrates an exemplary system, in accordance with one embodiment.

FIG. 2 illustrates a network architecture, in accordance with one possible embodiment

FIG. 3 illustrates a method for social voting for fashion purchase decisions.

### DETAILED DESCRIPTION

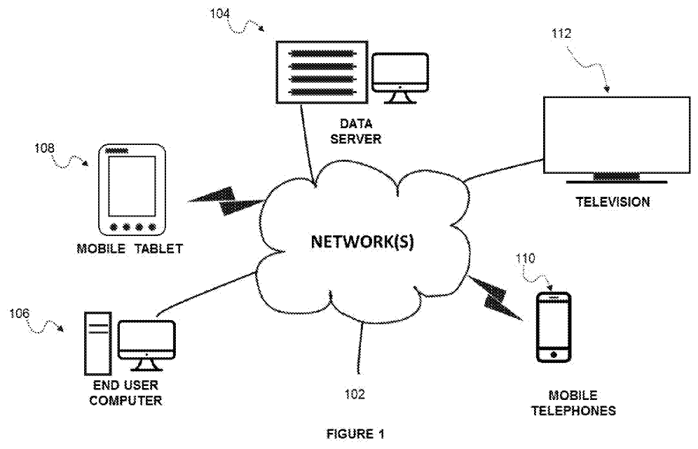

FIG. 1 illustrates a network architecture 100, in accordance with one possible embodiment. As shown, at least one network 102 is provided. In the context of the present network architecture 100, the network 102 may take any form including, but not limited to a telecommunications network, a local area network (LAN), a wireless network, a wide area network (WAN) such as the Internet, peer-to-peer network, cable network, etc. While only one network is shown, two or more similar or different networks 102 may be provided.

Coupled to the network 102 is a plurality of devices. For example, a server computer 104 and an end user computer 106 may be coupled to the network 102 for communication purposes. Such end user computer 106 may include a desktop computer, lap-top computer, and/or any other type of logic. Still yet, various other devices may be coupled to the network 102 including a personal mobile tablet 108, a mobile phone device 110, a television 112, etc.

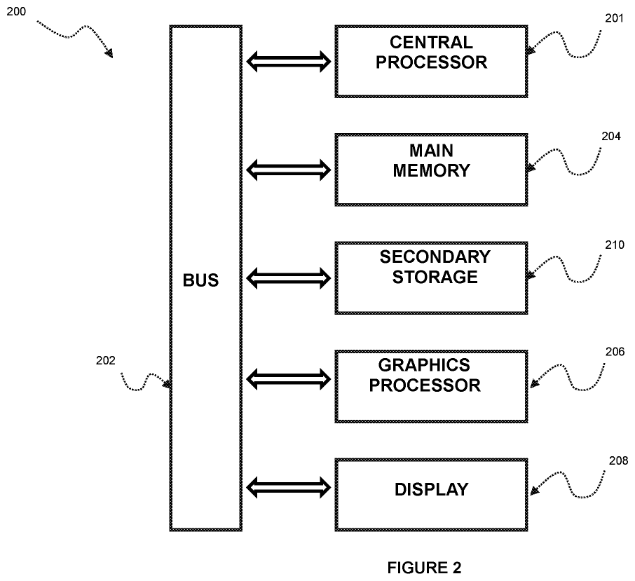

FIG. 2 illustrates an exemplary system 200, in accordance with one embodiment. As an option, the system 200 may be implemented in the context of any of the devices of the network architecture 100 of FIG. 1. Of course, the system 200 may be implemented in any desired environment.

As shown, a system 200 is provided including at least one central processor 201 which is connected to a communication bus 202. The system 200 also includes main memory 204 [e.g. random access memory (RAM), etc.]. The system 200 also includes a graphics processor 206 and a display 208.

The system 200 may also include a secondary storage 210. The secondary storage 210 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 204, the secondary storage 210, and/or any other memory, for that matter. Such computer programs, when executed, enable the system 200 to perform various functions (to be set forth below, for example). Memory 204, storage 210 and/or any other storage are possible examples of tangible computer-readable media.

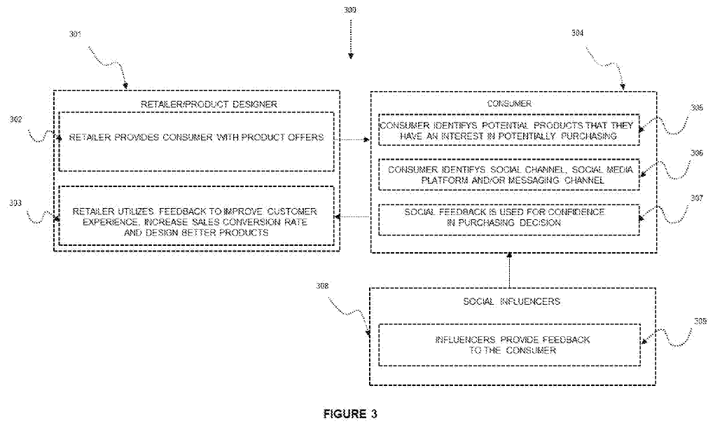

FIG. 3 illustrates a method 300 where the retailer/product designer 301 provides the consumer with product offerings 302. The consumer 304 identifies potential products that they have an interest in potentially purchasing 305. The consumer identifies the social channel 306 that they wish to use to reach their social influencers. The social channel may include but is not limited to popular social media platforms, messaging platforms, email and proprietary platforms. Social influencers 308 provide their feedback in the form of votes, favorites, comments or other means 309. Social feedback 307 is used for confidence in the consumers purchasing decision. The retailer 303 utilizes the social voting, favorites, comments, to improve their customer experience, sales conversion rate and to design better products.

1. A computer program product embodied on a non-transitory computer readable medium or mobile computing platform, comprising computer code for:
providing a social voting platform and confirmation of personal fashion choices to facilitate consumer purchases;
provides a means for the retailer to offer the consumer alternatives for comparison;
allows the consumer to filter potential products;
enables the consumer to request feedback from their social network;
enables the user's social network to provide voting-style feedback for the consumer before their decision to purchase; and
provides a vehicle to share commercial logos for the purpose of marketing or branding.

2. The computer program product of claim 1, wherein the retailer provides a mechanism for the consumer to select products that they may be interested in comparing.

3. The computer program product of claim 1, wherein the consumer determines the social network or communication channel they use for feedback.

4. The computer program product of claim 1, wherein the consumer provides one or more potential purchases to their social influencer network.

5. The computer program product of claim 1, wherein the consumer receives the feedback before they purchase the product. The consumer may use the feedback to facilitate purchasing decisions.

6. The computer program product of claim 1, wherein the consumer uses a photo of the product as a representation of the product and which will be used in the social voting and comment process.

7. The computer program product of claim 1, wherein the consumer uses digital try-on technology to create a derivative photo containing the consumer with the product for the use of evaluation, gaining social voting, and comment.

8. The computer program product of claim 1, wherein the retailer is provided with the consumers selections and the results of the social voting.

9. The computer program product of claim 1, wherein the retailer uses the social voting to optimize the purchasing experience.

10. The computer program product of claim 1, wherein the fashion designer is provided with the consumers selections and the results of the social voting.

11. The computer program product of claim 1, wherein the social network includes all social media platforms, messaging services, email and proprietary voting channels.

12. The computer program product of claim 1, wherein the process of sending the consumer selection allows the vendor to provide their own logo or branding message.
